(19) United States
(12) Patent Application Publication
(10) Pub. No.: US 2023/0394107 A1
(43) Pub. Date: Dec. 7, 2023

(54) THREE-DIMENSIONAL CONVOLUTION DEVICE AND THREE-DIMENSIONAL CONVOLUTION METHOD

(71) Applicant: SigmaStar Technology Ltd., Fujian (CN)

(72) Inventor: Yong-Sheng CHEN, Shanghai (CN)

(21) Appl. No.: 18/070,888

(22) Filed: Nov. 29, 2022

(30) Foreign Application Priority Data
Jun. 2, 2022 (CN) 202210629826.9

(51) Int. Cl. G06F 17/15

(52) U.S. Cl. CPC G06F 17/153

(57) ABSTRACT

A three-dimensional convolution method includes performing a dimension transposing operation on input data to consecutively arrange elements of the input data in depth and channel dimensions to further generate first data, performing in blocks a convolution on the first data and second data that corresponds to first weight data to generate computed data, and rearranging the computed data according to an original dimensional format of the input data to generate output data.

This application claims the benefit of China application Serial No. CN202210629826.9, filed on Jun. 2, 2022, the subject matter of which is incorporated herein by reference.

### BACKGROUND OF THE INVENTION

### Field of the Invention

The present application relates to a convolution device, and more particularly to a three-dimensional convolution device that performs three-dimensional convolutions by using a rearranged data dimensional format, and a method thereof.

### Description of the Related Art

Convolutions are common in artificial neural network models to determine whether similar features are present between multiple sets of data. In the prior art, multiple data values are accumulated in a depth dimension and a channel dimension in the calculation of three-dimensional convolutions. In current data formats, multiple data values in the depth dimension and multiple data values in the channel dimension are stored in a memory in a dispersed manner. As such, three-dimensional convolutions are made more complex. In addition, during three-dimensional convolutions, more time is needed to read the multiple dispersed data values, leading to degraded data access efficiency of a convolution device and hence poor processing efficiency of three-dimensional convolutions.

### SUMMARY OF THE INVENTION

In some embodiments, it is an object of the present application to provide a three-dimensional convolution device capable of enhancing processing efficiency of convolutions and a method thereof so as to improve the issues of the prior art.

In some embodiments, a three-dimensional convolution method includes performing a dimension transposing operation on input data to consecutively arrange elements of the input data in a depth dimension and a channel dimension to further generate first data, performing in blocks a convolution on the first data and second data corresponding to first weight data to generate computed data, and rearranging the computed data according to an original dimensional format of the input data to generate output data.

In some embodiments, a three-dimensional device includes a buffer, a direct memory access (DMA) circuit, a dimension transposing circuit and a convolution circuit. The DMA circuit reads input data from an external memory and stores the input data to the buffer. The dimension transposing circuit reads the input data from the buffer, and performs a dimension transposing operation on the input data to consecutively arrange multiple elements of the input data in a depth dimension and a channel dimension to further generate first data. The convolution circuit performs in blocks a convolution on the first data and second data that corresponds to first weight data to generate computed data. The dimension transposing circuit further rearranges the computed data according to an original dimensional format of the input data to generate output data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a three-dimensional convolution device according to some embodiments of the present application;

FIG. 2 is a flowchart of a three-dimensional convolution method according to some embodiments of the present application;

FIG. 3 is a schematic diagram of a dimensional transposing operation performed on input data in FIG. 1 to generate first data according to some embodiments of the present application;

FIG. 4A is a schematic diagram of blocked first data according to some embodiments of the present application;

FIG. 4B is a schematic diagram of blocked second data according to some embodiments of the present application;

FIG. 5A is a data flowchart of an operation of one single convolution layer according to some embodiments of the present application; and

FIG. 5B is a data flowchart of an operation of multiple convolution layers according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

In some embodiments, it is an object of the present application to enable a direct access memory (DMA) circuit to more efficiently read input data and weight data by using a rearranged data dimensional format, further enhancing the overall efficiency of convolutions.

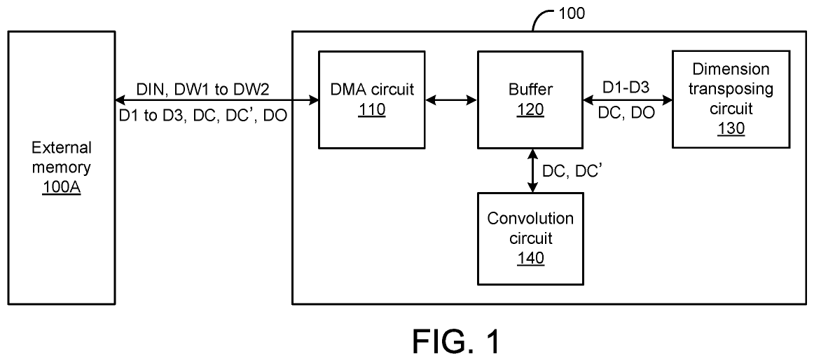

FIG. 1 shows a schematic diagram of a three-dimensional convolution device 100 according to some embodiments of the present application. In some embodiments, the three-dimensional convolution device 100 is controllable by a computing platform (operated on at least one computer host). In some embodiments, the three-dimensional convolution device 100 includes a processor (not shown), which is capable of controlling other circuits in the three-dimensional convolution device 100.

The three-dimensional device 100 includes a direct memory access (DMA) circuit 110, a buffer 120, a dimension transposing circuit 130 and a convolution circuit 140. The DMA circuit 110 may read and store input data DIN and weight data DW1 from an external memory 100A to the buffer 120. In some embodiments, the external memory 100A may be, for example but not limited to, a dynamic random access memory (DRAM). In some embodiments, the buffer 120 may be, for example but not limited to, a static random access memory (SRAM).

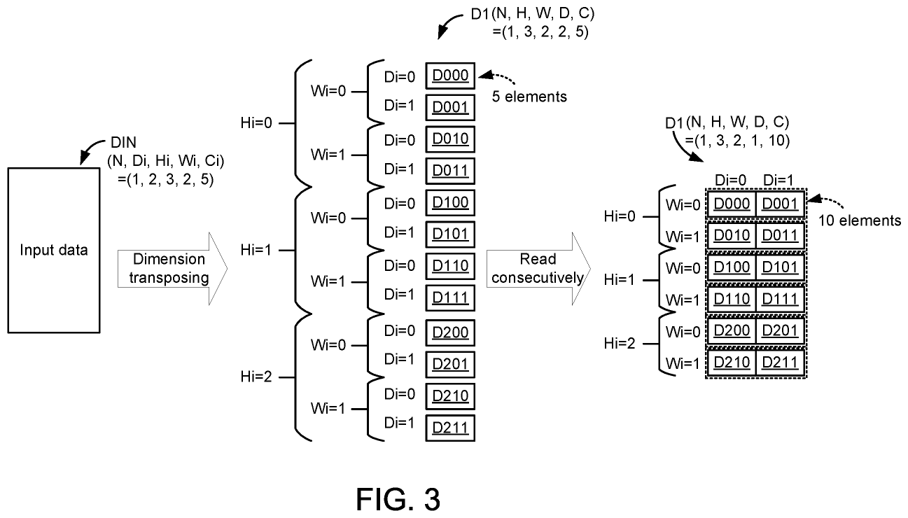

In some embodiments, a convolution performed by the three-dimensional convolution device 100 is a three-dimensional convolution. Correspondingly, the input data DIN may be a five-dimensional tensor, which has a five-dimensional format as its original dimensional format. For example, the order of the original dimensional format may be represented as (N, Di, Hi, Wi, Ci), where N is the batch and may be the dimension value of the highest dimension of the input data DIN, Di is a depth dimension, Hi is a height dimension, Wi is a width dimension, and Ci is a channel dimension. For example, in the example of FIG. 3 to be described later, the original dimensional format (N, Di, Hi, Wi, Ci) of the input data DIN is (1, 3, 2, 2, 5), which means that the number of elements of the input data DIN in the depth dimension is 3, the number of elements in the height dimension is 2, the number of elements in the width dimension is 2, and the number of elements in the channel dimension is 5. Similarly, the original dimensional format of the weight data DW1 may be represented as (Dk, Hk, Wk, Ck, Co), where Dk is a depth dimension, Hk is a height dimension, Wk is a width dimension, Ckis a channel dimension, and Co is the dimension value of the highest dimension (which is equal to the value of the channel dimension of output data DO) of the weight data DW1.

The dimension transposing circuit 130 reads the input data DIN and the weight data DW1 from the buffer 120, and performs a dimension transposing operation on the input data DIN according to a predetermined dimensional format (which may be specified by a computing platform) to consecutively arrange multiple elements of the input data DIN in the depth dimension and the channel dimension, so as to generate and store data D1 to the buffer 120. In some embodiments, the dimension transposing circuit 130 further performs a dimensional transposing operation on the weight data DW1 according to the predetermined dimensional format to consecutively multiple elements of the weight data DW1 in the depth dimension and the channel dimension, so as to generate and store data D2 to the buffer 120. The DMA circuit 110 may read and store data D1 and data D2 from the buffer 120 to the external memory 100A. With the above operation, the input data DIN in the original dimensional format and the weight data DW1 in the original dimensional format are respectively rearranged into the data D1 in the predetermined dimensional format and the data D2 in the predetermined dimensional format. Thus, the efficiency of convolutions can be enhanced. Details related to the dimension transposing operation are described with reference to FIG. 3 below. In some embodiments, the dimension transposing circuit 130 can be implemented by a data processing circuit executing a predetermined process or predetermined software. In some embodiments, if the weight data DW1 is constant data, the computing platform may store the data D2 corresponding to the weight data DW1 in advance in the external memory 100A, so as to further promote the processing efficiency of convolutions.

The DMA circuit 110 may read in blocks the data D1 and the data D2 from the external memory 100A to the buffer 120. The convolution circuit 140 may read the data D1 and the data D2 from the buffer 120, and perform in blocks a convolution on the data D1 and the data D2 to generate computed data DC. In some embodiments, the computing platform (or a processor of the convolution device 100) divides the data D1 and the data D2 into blocks according to the access bandwidth of the system, the capacity of the buffer 120, the dimensional size of the data D1 and the dimensional size of the data D2. As such, the computing platform (or the processor of the three-dimensional convolution device 100) can control the DMA circuit 110 to sequentially read the data blocks of the data D1 and the data blocks of the data D2 to the buffer 120, and control the convolution circuit 140 to sequentially read the data blocks of the data D1 and the data blocks of the data D2 from the buffer 120, and to perform a convolution in blocks. Once the convolution circuit 140 completes the convolution of all of the data blocks, the convolution operation circuit 140 can generate the computed data DC, and store the computed data DC through the buffer 120 and DMA circuit 110 to the external memory 100A. In some embodiments, the convolution circuit 140 can be implemented by a digital signal processing circuit.

The dimension transposing circuit 130 may read the computed data DC through the DMA circuit 110 and the buffer 120, and rearrange the computed data DC according to the original dimensional format of the input data DIN to generate the output data DO. The dimension transposing circuit 130 may dump the output data DO through the buffer 120 and the DMA circuit 110 to the external memory 100A. Thus, other devices in the computing platform are allowed to correctly access the output data DO for subsequent applications.

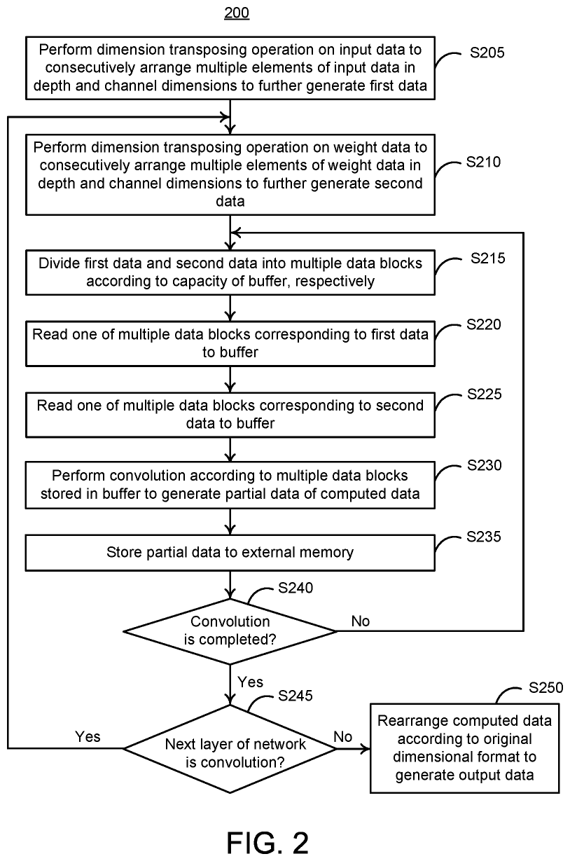

FIG. 2 shows a flowchart of a three-dimensional convolution method 200 according to some embodiments of the present application. In some embodiments, the convolution operation method 200 may be performed by, for example but not limited to, the convolution device 100 in FIG. 1. Refer to both FIG. 1 and FIG. 2 for better illustrating on operation details associated with the three-dimensional convolution device 100.

In operation S205, a dimension transposing operation is performed on input data to consecutively arrange multiple elements of the input data in a depth dimension and a channel dimension to further generate first data. In operation S210, a dimension transposing operation is performed on weight data to consecutively arrange multiple elements of the weight data in a depth dimension and a channel dimension to further generate second data. As described previously, the DMA circuit 110 may read and store the input data DIN and the weight data DW1 from an external memory 100A to the buffer 120. The dimension transposing circuit 130 may read the input data DIN and the weight data DW1 from the buffer 120, consecutively arrange multiple elements of the input data DIN in the depth dimension and the channel dimension to generate the data D1, and consecutively arrange multiple elements of the weight data DW1 in the depth dimension and the channel dimension to generate the data D2. Next, the dimension transposing circuit 130 dumps the data D1 and the data D2 through the buffer 120 and the DMA circuit 110 to the external memory 100A.

FIG. 3 shows a schematic diagram of a dimensional transposing operation performed on the input data DIN in FIG. 1 to generate the data D1 according to some embodiments of the present application. As described previously, the original dimensional format of the input data DIN may be represented as (N, Di, Hi, Wi, Ci). In the example in FIG. 3, the original dimensional format (N, Di, Hi, Wi, Ci) is (1, 2, 3, 2, 5). In other words, the input data DIN can be divided into three data groups (that is, multiple sets of data corresponding to Hi=0, 1, 2) in the height dimension Hi. Each data group may be further divided into two sub data groups in the width dimension Wi (that is, multiple groups of data corresponding to Wi=0, 1), and each sub data group may be further divided into two sets of data in the depth dimension (that is, multiple sets of data corresponding to Di=0, 1), wherein each set of data includes 5 elements (or referred to as data values; that is, corresponding to Ci=5). More specifically, the input data includes multiple sets of data D000, D001, D010, D011, . . . , D210 and D211, where D000 means that the corresponding height dimension Hi, width dimension Wi and depth dimension Di are all 0, and the data D0001 means that the corresponding height dimension Hi, width dimension Wi and depth dimension Di are sequentially 0, and 1. Similarly, the correspondence between the multiple sets of data above and the original dimensional formats thereof can be understood.

As shown in FIG. 3, the data D1 can be generated by consecutively arranging multiple elements of the input data DIN in the depth dimension Di and the channel dimension Ci, wherein the predetermined dimensional format of the data D1 sequentially includes batch, height dimension, width dimension, depth dimension and channel dimension, which are sequentially denoted as (N, H, W, D, C). Different from the original dimensional format of the input data DIN, the depth dimension D and the channel dimension C in the predetermined dimensional format of the data D1 are arranged in adjacent. With the above dimension transposing operation, it is seen that the multiple sets of data (that is, the data D000, D0001, D010, D011, . . . , D210 and D211) of the data D1 are consecutively arranged. In other words, the data can be consecutively stored in the external memory 100A (and/or the buffer 120). As such, during a convolution, the DMA circuit 110 can read the multiple sets of data of the data D1 from the external memory 100A to perform the convolution.

To explain from another perspective, in a two-dimensional convolution, a convolution kernel (equivalent to the weight data DW1) performs a slide operation on the width dimension and the height dimension of the input data as well as performs a multiplication-addition operation at the same time on corresponding multiple elements in the channel dimension to generate a convolution result. In comparison, in a three-dimensional convolution, a convolution kernel further performs the multiplication-addition operation on the depth dimension of the input data and corresponding elements to generate a convolution result. Accumulation is performed for both the depth dimension and the channel dimension in the three-dimensional convolution, and so the multiple elements of the input data DIN in the depth dimension and the channel dimension can be consecutively arranged to generate the data D1. As such, the operation of the three-dimensional convolution can be simplified to that similar to the operation of the two-dimensional convolution, further reducing the complexities and enhancing processing efficiency of the three-dimensional convolution.

More specifically, during a convolution, the convolution circuit 140 may consecutively read two sets of data of the data D1 through the DMA circuit 110 and the buffer 120 to perform one round of convolution. For example, assume that the two sets of data are D000 and D0001 including multiple (for example, 10) elements corresponding to different depths (Di is 0 or 1), and the elements correspond to the same width (Wi is 0) and the same height (Hi is 0). By means of dimension transposing and consecutive reading, the multiple sets of data can be consecutively arranged, and the number of dimensions of the depth dimension can be equivalently reduced. For example, the dimensional format (N, H, W, D, C) presented as the data D1 during the consecutive reading is equivalent to (1, 3, 2, 1, 10), wherein the number of dimensions of the depth dimension D is equivalently reduced to 1, and that of the channel dimension changes to 10. Thus, the number of elements read each time by the DMA circuit 110 can be increased, so as to improve the operating efficiency of the DMA circuit 110, thereby enhancing the calculation efficiency of the convolution. The input data DIN and the data D1 are used as an illustration example in FIG. 3. It should be understood that, the same operation in FIG. 3 is suitable for the weight data DW1 and the data D2 (or weight data DW2 and data D3 to be described shortly), and repeated details are omitted herein.

Again referring to FIG. 1 and FIG. 2, in operation S215, each of the first data and the second data is divided into multiple data blocks according to the capacity of a buffer. In operation S220, one of the multiple data blocks that corresponds to the first data is read to the buffer. In operation S225, one of the multiple data blocks that corresponds to the second data is read to the buffer. In operation S230, a convolution is performed according to the multiple data blocks stored in the buffer to generate partial data of computed data. In operation S235, the partial data is stored to an external memory.

As described previously, a computing platform (or a processor of the convolution device 100) may divide each of the data D1 and the data D2 into blocks according to the access bandwidth of the system, the capacity of the buffer 120, the dimensional size of the data D1 and the dimensional size of the data D2. In some embodiments, the divided data blocks meet the following conditions: the value of the channel dimension of the data D1 is equal to the value of the channel dimension of the data D2, and the value of sliding (or referred to as offset) of the data D2 in the channel dimension is equal to the value of the channel dimension of the output data DO; however, the present application is not limited to the above example. Once each of the data D1 and the data D2 is divided into multiple blocks, the DMA circuit 110 may read in blocks the data D1 and the data D2 to the buffer 120 (that is, reading one data block of the data D1 and one data block of the data D2 to the buffer 120 each time), so as to provide the convolution circuit 140 with the data blocks to perform one round of convolution and generate the partial data (equivalent to a result of this round of convolution) of the computed data DC. The DMA circuit 110 may read and store the partial data from the buffer 120 to the external memory 100A. In some embodiments, the data D1 and the data D2 may be divided into multiple blocks by a current scheduling algorithm or block convolution algorithm.

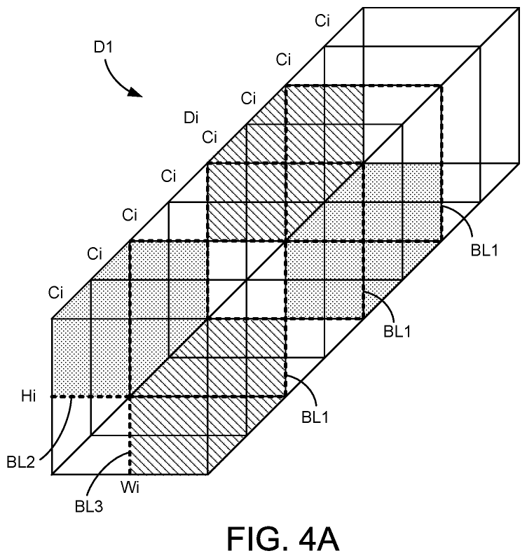

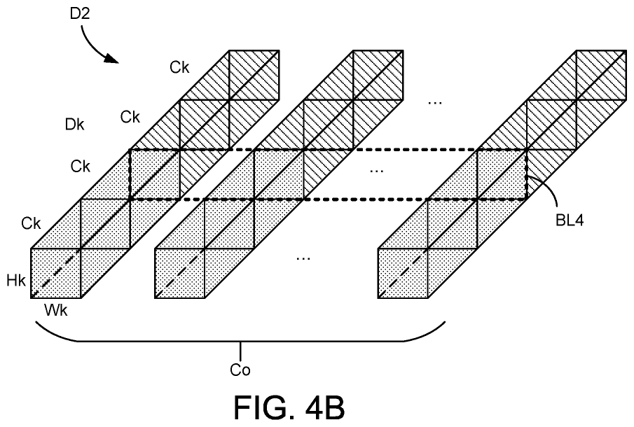

FIG. 4A shows a schematic diagram of blocked first data D1 according to some embodiments of the present application. In FIG. 4A, one square in the channel dimension Ci represents data of one tensor in the data D1. Because the channel dimension Ci and the depth dimension Di are combined into one dimension (in this example, the value of the channel dimension Ci is 8), the data D1 is blocked based on a boundary line BL1 (represented by a dotted line) in this dimension, and blocked based on a boundary line BL2 and a boundary line BL3 (represented by dotted lines) in the height dimension Hi and the width dimension Wi, respectively. Thus, the data D1 is divided into 16 data blocks. For better understanding, corresponding configurations of four data blocks are respectively shown in dots and slashes in FIG. 4A, and positions of the remaining data blocks can be deduced accordingly. In practice, the size of the data D1 is usually larger than the capacity of the buffer 120. Thus, the DMA circuit 110 may read in blocks one data block of the data D1 to the buffer 120, for the convolution circuit 140 to perform the convolution.

FIG. 4B shows a schematic diagram of blocked second data D2 according to some embodiments of the present application. In this example, the data D2 is divided into multiple data blocks in the channel dimension Ck (or the depth dimension Ck, the two are combined into one dimension) based on a boundary line BL4 (depicted by a dotted line). Since the size of the data D2 is generally small, further division in the height dimension Hk and the width dimension Wk is not performed in this example; however, the present application is not limited to the above example. For better understanding, corresponding configurations of multiple data blocks are respectively shown in dots and slashes in FIG. 4B. The DMA circuit 110 may read in blocks one data block of the data D2 to the buffer 120, for the convolution circuit 140 to perform the convolution.

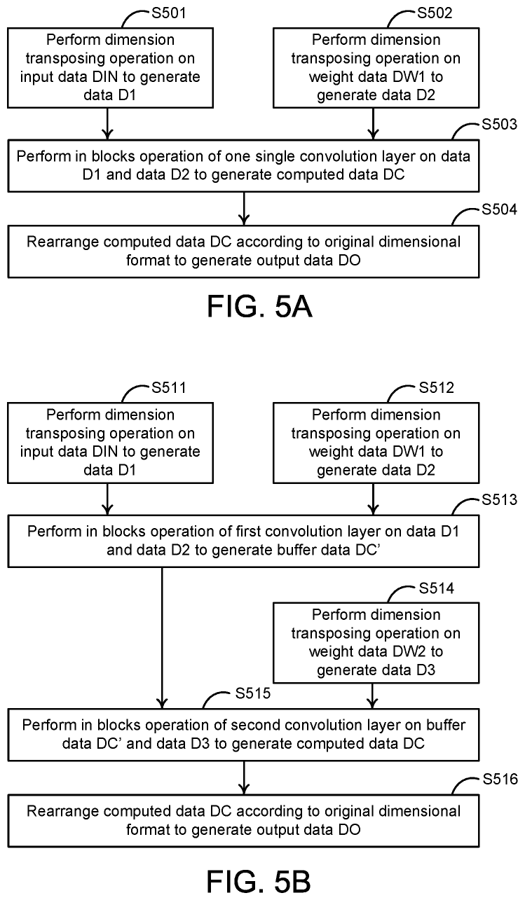

Again referring to FIG. 2, in operation S240, it is determined whether the convolution is completed. If the convolution is completed (that is, all data blocks have been computed), operation S245 is performed. Alternatively, if the convolution is not completed, operation S215 is again performed, so as to read next data blocks of the data D1 and the data D2 to continue performing the convolution. The complete computed data DC can be obtained by repeating the above steps. In operation S245, it is determined whether the next layer of the network is still the convolution. If the next layer is still the convolution, operation S210 is again performed, and the convolution of the next layer is again performed by the multiple operations above. Details related to operation S245 are given with reference to FIG. 5A and FIG. 5B below. Alternatively, if the next layer of the network is not the convolution, operation S250 is performed. In operation S250, the computed data is rearranged according to an original dimensional format of the input data to generate output data.

For example, if the next layer of the network is not the convolution, the DMA circuit 110 may read the computed data DC from the external memory 100A, and dump the computed data DC to the buffer 120. The dimension transposing circuit 130 may read the computed data DC from the buffer 120, rearrange the computed data DC according to the original dimensional format of the input data DIN to generate the output data DO, and store the output data DO to the buffer 120. The DMA circuit 110 may read and store the output data DO from the buffer 120 to the external memory 100A. Thus, other devices in the computing platform or the system are allowed to use the output data DO for subsequent data processing. In other words, with operation S250, the dimensional format of the output data DO is restored to the original dimensional format suitable for the computing platform, allowing other networks of the neural network model to correctly use the output data DO.

The plurality operations of the three-dimensional convolution method 200 above are merely examples, and are not limited to being performed in the order specified in this example. Without departing from the operation means and ranges of the various embodiments of the present application, additions, replacements, substitutions or omissions may be made to the operations of the three-dimensional convolution method 200, or the operations may be performed in different orders (for example, simultaneously performed or partially simultaneously performed).

FIG. 5A shows a data flowchart of an operation of one single convolution layer according to some embodiments of the present application. In this example, a neural network model operated by the three-dimensional convolution device 100 includes one single convolution layer (that is, the above convolution includes one single convolution layer). In operation S501, a dimension transposing operation is performed on input data DIN (that is, consecutively arranging multiple elements of the input data DIN in the depth dimension and the channel dimension) to generate data D1. In operation S502, a dimension transposing operation is performed on weight data DW1 (that is, consecutively arranging multiple elements of the weight data DW1 in the depth dimension and the channel dimension) to generate data D2. In operation S503, an operation of one single convolution layer is performed in blocks on the data D1 and the data D2 to generate computed data DC (equivalent to operation S215 to operation S240 in FIG. 2). In operation S503, the computed data DC is rearranged according to an original dimensional format to generate output data DO.

Details associated with the multiple operations in FIG. 5A can be referred from the details associated with the operations in FIG. 2, and are omitted herein. As described previously, in this example, the convolution includes only one single convolution layer, and so the dimension of the computed data DC can be restored according to the original dimensional format after performing operation S503, so as to generate the output data DO.

FIG. 5B shows a data flowchart of an operation of multiple convolution layers according to some embodiments of the present application. Compared to FIG. 5A, in the example in FIG. 5B, a neural network model operated by the three-dimensional convolution device 100 includes multiple convolution layers; for example, the above convolution includes a first convolution layer and a second convolution layer.

In operation S511, a dimension transposing operation is performed on input data DIN to generate data D1. In operation S512, a dimension transposing operation is performed on weight data DW1 to generate data D2. In operation S513, an operation of the first convolution layer is performed in blocks on the data D1 and the data D2 to generate buffer data DC′ (which may be stored in the buffer 120 in FIG. 1). In operation S514, a dimension transposing operation is performed on weight data DW2 (that is, consecutively arranging multiple elements of the weight data DW2 in the depth dimension and the channel dimension, wherein the weight data DW2 is equivalent to a convolution kernel of the second convolution layer) to generate data D3 (which may be stored in the external memory 100A in FIG. 1, and may be dumped through the DMA circuit 110 to the buffer 120). In operation S515, an operation of the second convolution layer is performed in blocks on the buffer data DC′ and the data D3 to generate computed data DC. In operation S516, the computed data DC is rearranged according to an original dimensional format to generate output data DO. Details associated with the multiple operations in FIG. 5B can be referred to the details associated with the operations in FIG. 2, and are omitted herein. For example, the details of the operation S513 and operation S515 can be referred to the details in the description associated with operation S215 to operation S240. In some other embodiments, if the weight data DW2 is constant data, the computing platform may store the data D3 corresponding to the weight data DW2 in advance in the external memory 100A.

As described previously, in this example, the convolution includes two convolution layers. Thus, a calculation result (that is, the buffer data DC′) obtained by the first convolution layer in a non-rearranged dimensional format may be directly input to the second convolution layer. In other words, in a neural network model including multiple convolution layers, a calculation result (that is, the computed data DC) of the last convolution layer (in this example, the second convolution layer) may be rearranged according to an original dimensional format to obtain the output data DO, instead of having to restore a result obtained by each convolution layer in an original dimensional format. As such, the processing efficiency of the convolution can be enhanced.

The multiple examples above are described by way of a three-dimensional convolution, and it should be noted that the present application is not limited to these examples. It should be understood that, the operation of rearranging the dimensions of data can be extended to convolutions of higher dimensions.

In conclusion, the three-dimensional convolution device and three-dimensional convolution method according to some embodiments of the present application are capable of enhancing access efficiency of a DMA circuit by means of rearranging a dimensional format of data. Further, with the above rearrangement, complexities of the three-dimensional convolution can be reduced, further enabling the three-dimensional convolution device to perform an operation similar or identical to that of a two-dimensional convolution to achieve the three-dimensional convolution. As such, the processing efficiency of the three-dimensional convolution can be enhanced.

While the present application has been described by way of example and in terms of the preferred embodiments, it is to be understood that the disclosure is not limited thereto. Various modifications made be made to the technical features of the disclosure by a person skilled in the art on the basis of the explicit or implicit disclosures of the present application. The scope of the appended claims of the disclosure therefore should be accorded with the broadest interpretation so as to encompass all such modifications.

What is claimed is:

1. A three-dimensional convolution method, comprising:
performing a dimension transposing operation on input data to consecutively arrange a plurality of elements of the input data in a depth dimension and a channel dimension to generate first data;
performing in blocks a convolution on the first data and second data that corresponds to first weight data to generate computed data; and
rearranging the computed data according to an original dimensional format of the input data to generate output data.

2. The three-dimensional convolution method according to claim 1, wherein the performing in blocks of a convolution on first data and second data to generate computed data comprises:
consecutively reading a plurality of elements of the first data that correspond to different depths to perform the convolution, wherein the elements correspond to a same width and a same height.

3. The three-dimensional convolution method according to claim 1, further comprising:
performing a dimension transposing operation on the first weight data to consecutively arrange a plurality of elements of the first weight data in the depth dimension and the channel dimension to further generate the second data.

4. The three-dimensional convolution method according to claim 1, wherein the convolution comprises a first convolution layer and a second convolution layer, and the performing in blocks of a convolution on first data and second data that corresponds to first weight data to generate computed data comprises:
performing in blocks an operation of the first convolution layer on the first data and the second data to generate buffer data;
performing a dimension transposing operation on second weight data to consecutively arrange a plurality of elements of the second weight data in the depth dimension and the channel dimension to further generate third data; and
performing in blocks an operation of the second convolution layer on the buffer data and the third data to generate the computed data.

5. A three-dimensional convolution device, comprising:
a buffer;
a direct memory access (DMA) circuit, reading input data from an external memory and storing the input data to the buffer;
a dimension transposing circuit, reading the input data from the buffer, and performing a dimension transposing operation on the input data to consecutively arrange a plurality of elements of the input data in a depth dimension and a channel dimension to generate first data; and
a convolution circuit, performing in blocks a convolution on the first data and second data that corresponds to first weight data to generate computed data;
wherein, the dimension transposing circuit further rearranges the computed data according to an original dimensional format of the input data to generate output data.

6. The three-dimensional convolution device according to claim 5, wherein the external memory further stores the second data, and a plurality of elements of the second data in the depth dimension and the width dimension are consecutively arranged.

7. The three-dimensional convolution device according to claim 5, wherein the DMA circuit further reads the first weight data from the external memory to the buffer, and the dimension transposing circuit further reads the first weight data from the buffer and performs the dimension transposing operation on the first weight data to consecutively arrange a plurality of elements of the first weight data in the depth dimension and the channel dimension to generate the second data.

8. The three-dimensional convolution device according to claim 5, wherein the convolution circuit consecutively reads a plurality of elements of the first data that correspond to different depths to perform the convolution, wherein the elements correspond to a same width and a same height.

9. The three-dimensional convolution device according to claim 5, wherein the convolution comprises a first convolution layer and a second convolution layer, and the convolution circuit performs in blocks of an operation of the first convolution layer on the first data and the second data to generate buffer data, and performs in blocks an operation of the second convolution layer on the buffer data and third data that corresponds to second weight data to generate the computed data.

10. The three-dimensional convolution device according to claim 9, wherein the DMA circuit further reads the second weight data from the external memory to the buffer, and the dimension transposing circuit further reads the second weight data from the buffer and performs the dimension transposing operation on the second weight data to consecutively arrange a plurality of elements of the first weight data in the depth dimension and the channel dimension to generate the third data.

11. The three-dimensional convolution device according to claim 5, wherein the first data generated by the dimension transposing circuit is stored through the buffer and the DMA circuit to the external memory, and the convolution circuit reads in blocks the first data through the DMA circuit and the buffer.
